(19) United States
(12) Patent Application Publication
(10) Pub. No.: US 2020/0406759 A1
(43) Pub. Date: Dec. 31, 2020

(54) VEHICLE ROOF STRUCTURE

(71) Applicant: Toyota Jidosha Kabushiki Kaisha, Toyota-shi Aichi-ken (JP)

(72) Inventors: Masaki Shitara, Nagakute-shi (JP); Yuchi Yamanouchi, Toyota-shi (JP); Ryo Hattori, Kariya-shi (JP)

(21) Appl. No.: 16/909,571

(22) Filed: Jun. 23, 2020

(30) Foreign Application Priority Data
Jun. 28, 2019 (JP) 2019-121600

(51) Int. Cl. B60L 8/00; B62D 25/06; G01S 17/931; G01S 19/14

(52) U.S. Cl. CPC B60L 8/003; G01S 19/14; G01S 17/931; B62D 25/06

(57) ABSTRACT

A vehicle includes a roof that is elongated in the longitudinal direction of the vehicle. Two solar panels are arranged on the roof along a longitudinal direction of the vehicle such that they are spaced from each other longitudinally. A lidar transmitter-receiver is disposed between the two solar panels.

### CROSS REFERENCE TO RELATED APPLICATION

This application claims priority to Japanese Patent Application No. 2019-121600 filed on Jun. 28, 2019 which is incorporated herein by reference in its entirety including the specification, claims, drawings, and abstract.

### TECHNICAL FIELD

The present disclosure relates to a vehicle roof structure including a solar panel mounted on a roof of a vehicle.

### BACKGROUND

Vehicles having photovoltaic power generation panels, that is, solar panels, mounted on their roofs are known. JP 2009-10127 A discloses a solar cell module that is movable within a roof of a vehicle.

Automated operation vehicles may include distance-measuring equipment for measuring a distance using a laser beam, known as lidar or LIDAR, in order to monitor a region around the vehicle. Such a lidar, particularly the transmitter-receiver for laser light, is typically mounted on a roof of a vehicle to enable monitoring of an area surrounding the vehicle. No suggestions, however, have been made concerning the arrangement of a solar panel with a transmitter-receiver of lidar mounted on a roof of a vehicle.

### SUMMARY

One embodiment of the present disclosure is directed toward the position of a lidar transmitter-receiver which has an effect of monitoring the area around a vehicle that has solar panels mounted on its roof.

In accordance with an aspect of the disclosure, a vehicle roof structure includes two solar panels arranged along a longitudinal direction of a vehicle on a roof of the vehicle such that the two solar panels are spaced from each other in the longitudinal direction, and a lidar transmitter-receiver disposed between the two solar panels. This configuration may substantially equalize the monitoring range of the lidar between the forward range and the rearward range.

The vehicle roof structure may further include a GPS receiver disposed near the lidar transmitter-receiver between the two solar panels. This configuration enables bundling together of the cabling for the lidar transmitter-receiver and the GPS receiver.

The vehicle roof structure may further include two solar panels disposed at opposite lateral ends of a region between the two solar panels arranged along the longitudinal direction. This configuration allows effective use of the region between the solar panels.

The transmitter-receiver of the lidar may be disposed in the center portion of the roof in the longitudinal direction of the vehicle. This configuration makes the forward monitoring region and the rearward monitoring region of the lidar symmetrical.

The roof may be elongated in the longitudinal direction of the vehicle.

### BRIEF DESCRIPTION OF DRAWINGS

Embodiments of the present disclosure will be described by reference to the following figures, wherein:

FIG. 1 is a perspective view illustrating an outer appearance of a vehicle according to an embodiment;

FIG. 2 is a plan view illustrating one example vehicle roof structure; and

FIG. 3 is a plan view illustrating another example vehicle roof structure.

### DESCRIPTION OF EMBODIMENTS

Embodiments of the present disclosure will be described by reference to the drawings. In the following description, unless specified otherwise, terms that refer to relative positions and directions, such as front, forward, rear, rearward, left, leftward, right, rightward, above, upward, below, downward, denote relative positions and directions with respect to a vehicle. A direction extending along a length of a vehicle will be referred to as a longitudinal direction, a direction extending along a width of a vehicle will be referred to as a lateral direction, and a direction extending along a height of a vehicle will be referred to as a vertical direction. In each drawing, an arrow FR indicates forward, an arrow UP indicates upward, and an arrow LH indicates leftward.

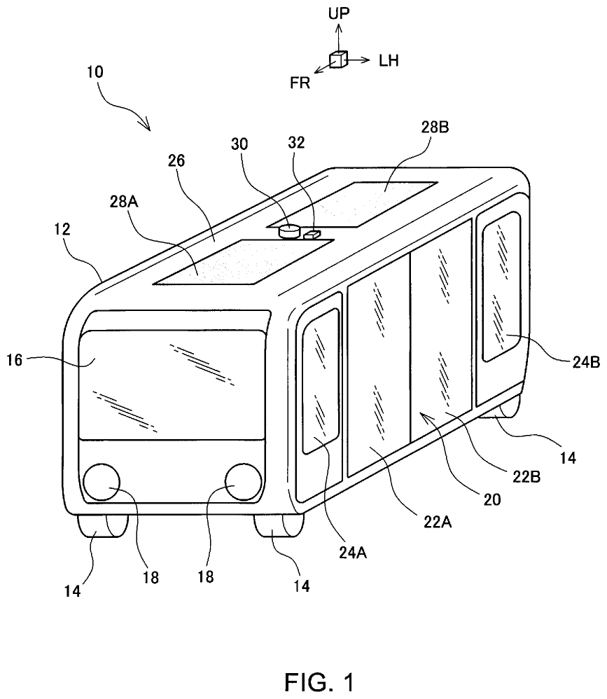

FIG. 1 is a perspective view schematically illustrating an outer appearance of a vehicle 10. The vehicle 10 can travel, by automated operation, along an ordinary road and does not require a specialized roadway, such as a railroad track. The vehicle 10 is an electric vehicle. The vehicle 10 includes a vehicle body 12 having a substantially rectangular parallelepiped shape. The vehicle body 12 has the largest dimension along its length, followed by the second largest dimension along its height. The vehicle body 12 includes wheels 14 at its four corners, respectively. The vehicle body 12 includes a windshield 16 in an upper region of its front face and includes head lamps 18 at opposite ends of a lower region of its front face. The vehicle body 12 further includes, on its rear face, a back window glass panel (not shown) having the same shape as the windshield 16 on the front face, and rear combination lamps (not shown) at locations corresponding to the locations of the head lamps 18 on the front face.

The vehicle body 12 includes, on its side face, a door 20 for boarding and exiting. The door 20 is disposed on one of the side faces: a left side face in an area of left-hand traffic and a right side face in an area of right-hand traffic. The vehicle body 12 may include doors 20 on both side faces. The door 20 includes two door panels 22A and 22B that slide along the longitudinal direction of the vehicle for opening and closing the door 20. Each of the door panels 22A and 22B includes a door glass panel to form a door window. The door 20 is disposed substantially in the center of a side face of the vehicle body 12 in the longitudinal direction of the vehicle. The vehicle body 12 further includes side window glass panels 24A and 24B disposed in forward and rearward regions with respect to the door 20, respectively, to form side windows. The vehicle body 12 includes a side window formed substantially over the entire area along the longitudinal direction of the vehicle body 12 on a side face where the door 20 is not disposed.

The vehicle 10 includes, on its roof 26, solar panels 28A and 28B, a transmitter-receiver 30 of lidar (which will be hereinafter referred to as a “lidar transmitter-receiver 30”), and a GPS receiver 32. In the following description, the two solar panels 28A and 28B will be referred to simply as the solar panels 28 unless there is need to distinguish one from the other. Each solar panel 28 is a device including arrays of a plurality of solar cells that receives sunlight to generate electricity. Electric power generated by the solar panels 28A and 28B is stored in a battery (not shown) mounted in the vehicle 10. The lidar is a device that measures a distance to a surrounding object using light such as laser light, and is used to monitor surrounding buildings and obstacles. The transmitter-receiver that emanates laser light and receives scattered light from the object is mounted on the roof 26 of the vehicle. A processor that processes a received signal may be integrally formed with the lidar transmitter-receiver 30 or may be disposed individually. In this illustrated example, the vehicle 10 includes integral lidar. Automated operation is performed based on information concerning the target, buildings, and obstacles in the surrounding area, for example, detected by the lidar and other sensors, and, for example, command instruction information. The GPS receiver 32 receives electronic signals from a global positioning system (GPS) satellite, and the received signal is processed by the processor to calculate a position of the vehicle 10. The processor may be integral with the GPS receiver 32, or may be disposed individually.

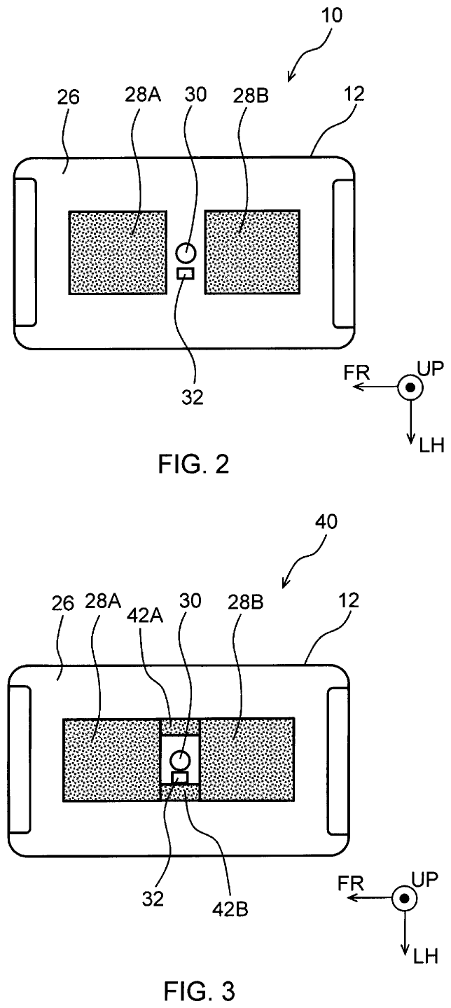

FIG. 2 schematically illustrates the vehicle 10 viewed from above, and specifically illustrates the arrangement of devices on the roof 26. The solar panels 28 are arranged in the longitudinal direction such that they are spaced apart from each other. A forward panel corresponds to the solar panel 28A and a rearward panel corresponds to the solar panel 28B. The lidar transmitter-receiver 30 and the GPS receiver 32 are disposed between the two solar panels 28A and 28B. The solar panels 28A and 28B may have the same shape. The lidar transmitter-receiver 30, disposed between the two solar panels 28A and 28B, can be placed in the center part of the roof 26 in the longitudinal direction of the vehicle. If the lidar transmitter-receiver 30 is disposed toward the front end or the rear end of the roof 26 that is elongated in the longitudinal direction of the vehicle, the monitoring range may differ between the forward range and the rearward range with respect to the vehicle. For example, if the lidar transmitter-receiver 30 is disposed near the front end of the roof 26, while a region near the front edge of the vehicle 10 would be included in the forward monitoring range, the rearward monitoring range would not be able to include a region as close to the vehicle. This tendency is noticeable especially when the roof is elongated in the longitudinal direction of the vehicle. By disposing the lidar transmitter-receiver 30 in the center portion of the roof 26, the same or symmetrical monitoring ranges can be set for the forward range and the rearward range. Further, if a vehicle, such as a railway vehicle, switches the travelling direction, the forward monitoring range and the rearward monitoring range that are symmetrical allow the lidar to maintain a consistent forward monitoring range to perform consistent monitoring in either direction. The lidar transmitter-receiver 30 is disposed in the center portion in the lateral direction of the vehicle as well. This configuration enables setting of identical monitoring ranges on the leftward and rightward sides of the vehicle.

The GPS receiver 32 is disposed between the solar panels 28A and 28B, particularly beside the lidar transmitter-receiver 30. This configuration enables effective use of a region between the solar panels 28A and 28B. This configuration further enables the bundling together of cabling associated with the lidar transmitter-receiver 30 and the GPS receiver 32, such as power cables, thereby reducing the space required for these cables.

FIG. 3 illustrates another example arrangement of the solar panels. Elements that are the same as those in FIG. 2 are denoted with the same reference numerals and will not be described. A vehicle 40 further includes solar panels 42A and 42B at opposite lateral end portions, respectively, of the region between the longitudinally arranged solar panels 28A and 28B. This configuration enables effective use of the region between the solar panels 28A and 28B that are arranged along the longitudinal direction.

While the vehicle 10,40 described above is an electric vehicle and uses an electric motor as a power source, the vehicle 10,40 may use a hybrid power source formed of an electric motor and an engine, or may use only an engine as a power source.

1. A vehicle roof structure comprising:
two solar panels arranged along a longitudinal direction of a vehicle on a roof of the vehicle such that the two solar panels are spaced apart from each other in the longitudinal direction; and
a transmitter-receiver of lidar disposed between the two solar panels.

2. The vehicle roof structure according to claim 1, further comprising:
a GPS receiver disposed near the transmitter-receiver of the lidar between the two solar panels.

3. The vehicle roof structure according to claim 1, further comprising:
two solar panels disposed at opposite lateral ends of a region between the two solar panels arranged in the longitudinal direction.

4. The vehicle roof structure according to claim 1, wherein
the transmitter-receiver of the lidar is disposed in a center portion of the roof in the longitudinal direction of the vehicle.

5. The vehicle roof structure according to claim 1, wherein
the roof is elongated in the longitudinal direction of the vehicle.
